(19) United States
(12) Patent Application Publication
(10) Pub. No.: US 2010/0017277 A1
(43) Pub. Date: Jan. 21, 2010

(54) System and Method for Electronic Coupon Service Using Smart Card

(75) Inventor: Yong-Jin Ha, Seoul (KR)

Correspondence Address: CROWELL & MORING LLP;INTELLECTUAL PROPERTY GROUP, P.O. BOX 14300, WASHINGTON, DC, 20044-4300, US

(73) Assignee: Yong-Jin HA, Seoul (KR)

(21) Appl. No.: 12/528,756

(22) PCT Filed: Feb. 27, 2008
(86) PCT No.: PCT/KR08/01120

§ 371 Date: Aug. 26, 2009

(30) Foreign Application Priority Data
Feb. 27, 2007 (KR) 10-2007-0019660

(51) Int. Cl. G06Q 30/00

(52) U.S. Cl. 705/14.1

(57) ABSTRACT

The present invention provides a system and method for an electronic coupon service using a smart card, which can prevent illegal use of electronic coupons and can identify information about service in real time. The method includes the steps of: issuing, by an electronic coupon server, an electronic coupon to an authenticated user smart card at the request of a user who wants the electronic coupon to be issued; distributing, by a service terminal, the electronic coupon, which has been issued by the electronic coupon server, to the user smart card when the user smart card is inserted into the service terminal; and transferring, by the service terminal, the electronic coupon stored in the user smart card to a service provider smart card at the time of providing the service by the service provider, and provides an electronic coupon service system using the smart card, which can achieve the method.

### TECHNICAL FIELD

The present invention relates to a system and method an electronic coupon service, and more particularly to a system and method an electronic coupon service using a smart card.

### BACKGROUND ART

In general, coupons are widely used as a marketing means for promoting the sale of products or services, and for advertising company names and product names. The coupons are used to provide services, such as discounting a specific product, providing some products free of charge, etc.

Such a coupon is provided as a piece of printed-paper having a predetermined size, and alternatively, a plurality of coupons are combined and provided as a coupon book. Recently, electronic coupons (i.e. E-coupons) have been provided through the Internet or the like. The electronic coupons are either printed through an output device, such as a printer, or are displayed on a screen of a portable communication terminal, such as a cellular phone, so as to be used.

Meanwhile, public institutions enforce the voucher system to offer social welfare service in order to expand social services for a low birth rate and aging due to the advance of society, and social service for weaker peoples, such as mentally or physically handicapped persons who draw small incomes, elderly people living alone, children, etc.

The “voucher” means a ticket which a public institution issues for a certificate of payment in order to directly assist a specific beneficiary in paying for the purchase of welfare services, such as education, housing, medical treatment, etc., and may be called a coupon.

A public institution issues a voucher to the service beneficiary free of charge or for a fee, and requests a service providing company to provide a planned specific service when the user requests the service. When the service provider has received the service provision request, the service provider provides the specific service to the user, and withdraws a predetermined voucher according to the amount of provided service.

However, since the conventional social welfare service is provided in a provider-based support scheme, there are problems in that it is difficult to reflect the desire of users, and service is one-sidedly provided to the user.

In addition, the voucher must be used as payment for a planned specific service according to the purpose of the social welfare service, but there is still a probability that the voucher is to be illegally used for services or products other than the specific welfare service.

In addition, it is difficult to identify information about types of service for which vouchers have been used, the number of times of use, provider preferences, etc., so that there are problems in that it is difficult for public institutions to identify the current problems of the voucher system, and it is difficult to expect improvement in the quality of service provided by providers.

### DISCLOSURE OF INVENTION

### Technical Problem

Therefore, the present invention has been made in view of the above-mentioned problems, and an object of the present invention is to provide a system and method for an electronic coupon service using a smart card, which promotes improvement in the quality of a service system by reflecting the opinions of users, who use the service, by means of electronic coupons.

Another object of the present invention is to provide a system and method for an electronic coupon service using a smart card, which can completely remove a probability that electronic coupons are to be illegally used for services or products other than the planned service.

Still another object of the present invention is to provide a system and method for an electronic coupon service using a smart card, which can identify various pieces of information about service, for which electronic coupons are used, in real time.

### Technical Solution

In order to achieve the above-mentioned objects, there is provided a system for an electronic coupon service using a smart card, the system including: an electronic coupon server for issuing an electronic coupon to an authenticated user smart card at the request of a user who wants the electronic coupon to be issued; and a service terminal for distributing the electronic coupon, which has been issued by the electronic coupon server, to the user smart card when the user smart card is inserted into the service terminal, wherein the service terminal includes an electronic coupon transference unit, which transfers the electronic coupon stored in the user smart card to a service provider smart card at the time of providing the service by the service provider.

The user smart card may store at least one piece of information among user information, information about service types to be usable by the user, information about the number of electronic coupons, and information about an available period of each electronic coupon, and the service provider smart card may include information about a service provider.

The service terminal may further include a service start time setting unit for setting a service start time when the user smart card and the service provider smart card are successively inserted into the service terminal.

The service terminal may further include a service end time setting unit for setting a service end time when the user smart card and the service provider smart card are successively inserted into the service terminal.

The service terminal may further include a user satisfaction rating reception unit for receiving a user satisfaction rating of the service.

The service terminal may further include a transmission unit, which transmits at least one piece of information among pieces of information about the user, provider, service type, service satisfaction, service time, and transference of an electronic coupon, to the electronic coupon server.

The electronic coupon server may further include a service request processing unit, which receives information about a service request from the user who wants to receive the service, and provides the received information to a service provider.

The electronic coupon server may further include an information classification unit, which receives at least one piece of information among pieces of information about the user, provider, service type, service satisfaction, service time, and transference of an electronic coupon, and classifies the received information.

The electronic coupon server may further include a user authentication unit, which receives a user approval request from a person who wants the service, and performs authentication of the person.

The electronic coupon service system using the smart card may further include an electronic coupon database for storing at least one piece of information among pieces of information about the user, provider, service type, service satisfaction, service time, and transference of an electronic coupon.

The electronic coupon may be a voucher electronic coupon.

According to another aspect of the present invention, there is provided a method for an electronic coupon service using a smart card, the method including the steps of: issuing, by an electronic coupon server, an electronic coupon to an authenticated user smart card at the request of a user who wants the electronic coupon to be issued; distributing, by a service terminal, the electronic coupon, which has been issued by the electronic coupon server, to the user smart card when the user smart card is inserted into the service terminal; and transferring, by the service terminal, the electronic coupon stored in the user smart card to a service provider smart card at the time of providing the service by the service provider.

The user smart card may store at least one piece of information among user information, information about service types to be usable by the user, information about the number of electronic coupons, and information about an available period of each electronic coupon, and the service provider smart card may include information about a service provider.

The electronic coupon service method using the smart card may further include a step of setting, by the service terminal, a service start time when the user smart card and the service provider smart card are successively inserted into the service terminal.

The electronic coupon service method using the smart card may further include a step of setting, by the service terminal, a service end time when the user smart card and the service provider smart card are successively inserted into the service terminal.

The electronic coupon service method using the smart card may further include a step of receiving, by the service terminal, a user satisfaction rating of the service.

The electronic coupon service method using the smart card may further include a step of transmitting, by the service terminal, at least one piece of information among pieces of information about the user, provider, service type, service satisfaction, service time, and transference of an electronic coupon, to the electronic coupon server.

The electronic coupon service method using the smart card may further include a step of receiving, by the electronic coupon server, information about a service request from the user who wants to receive the service, and providing the received information to a service provider.

The electronic coupon service method using the smart card may further include a step of receiving, by the electronic coupon server, at least one piece of information among pieces of information about the user, provider, service type, service satisfaction, service time, and transference of an electronic coupon, and classifying the received information.

The electronic coupon service method using the smart card may further include a step of receiving, by the electronic coupon server, a user approval request from a person who wants the service, and performing authentication of the person.

The electronic coupon service method using the smart card may further include a step of storing at least one piece of information among pieces of information about the user, provider, service type, service satisfaction, service time, and transference of an electronic coupon in an electronic coupon database.

The electronic coupon may be a voucher electronic coupon.

### ADVANTAGEOUS EFFECTS

The present invention is to provide a system and method for an electronic coupon service using a smart card, which can completely remove a probability that electronic coupons are to be illegally used for services or products other than the planned service, and can identify various pieces of information about service, for which electronic coupons are used, in real time.

### BRIEF DESCRIPTION OF THE DRAWINGS

FIG. 1 is a block diagram illustrating the configuration of an electronic coupon service system using a smart card according to an exemplary embodiment of the present invention;

FIG. 2 is a block diagram illustrating the configuration of a service terminal according to an exemplary embodiment of the present invention;

FIG. 3 is a block diagram illustrating the configuration of a controller in the service terminal according to an exemplary embodiment of the present invention;

FIG. 4 is a block diagram illustrating the configuration of an electronic coupon server according to an exemplary embodiment of the present invention;

FIG. 5 is a flowchart illustrating a procedure of issuing a user smart card according to an exemplary embodiment of the present invention;

FIG. 6 is a flowchart illustrating a procedure of issuing an electronic coupon according to an exemplary embodiment of the present invention; and

FIG. 7 is a flowchart illustrating an electronic coupon service method using a smart card according to an exemplary embodiment of the present invention.

### REFERENCE NUMERALS OF SEVERAL ELEMENTS IN DRAWINGS

101: network
103: electronic coupon server
105: electronic coupon DB 107: service terminal
109: user smart card
111: service provider smart card
113: user 115: user terminal
117: service provider
119: service provider terminal

### MODE FOR THE INVENTION

Hereinafter, preferred embodiments of the present invention will be described in more detail with reference to the accompanying drawings.

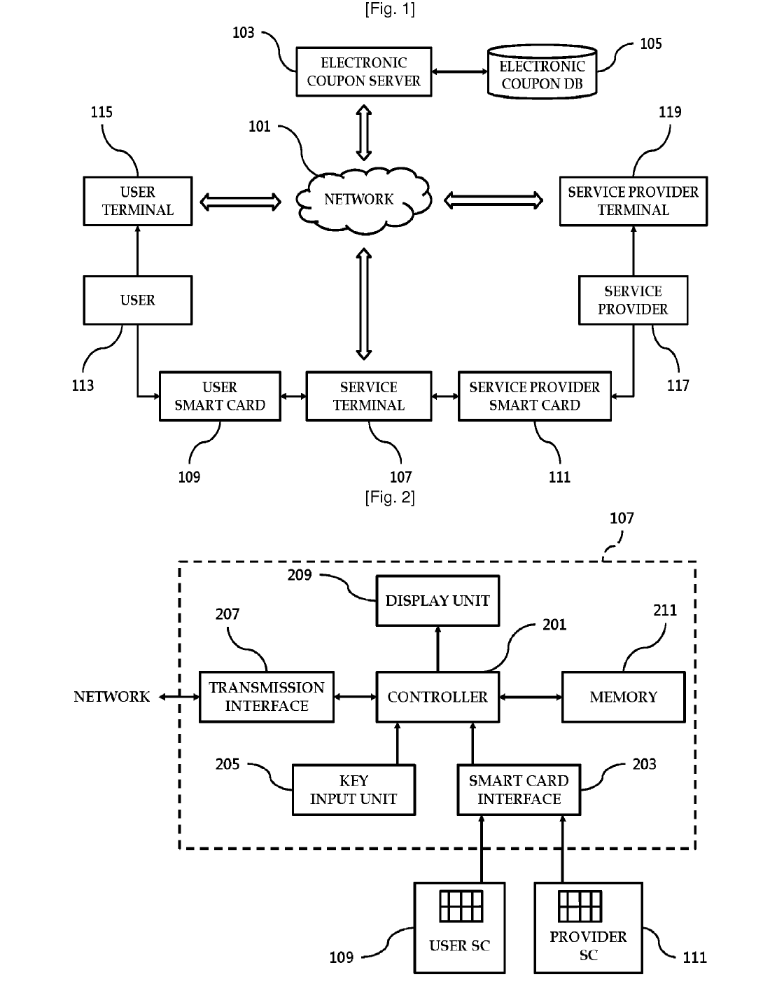

FIG. 1 is a block diagram illustrating the configuration of an electronic coupon service system using a smart card according to an exemplary embodiment of the present invention.

Referring to FIG. 1, the electronic coupon service system using a smart card according to an exemplary embodiment of the present invention includes an electronic coupon server 103, an electronic coupon database 105, a service terminal 107, a user smart card 109, a service provider smart card 111, a user terminal 115, and a service provider terminal 119.

The electronic coupon server 103 is connected to a network 101, and issues an electronic coupon to the user smart card 109, which has been authenticated, at the request of a user 113, who wants the electronic coupon to be issued.

In addition, the electronic coupon server 103 may receive service request information from the user 113, who wants to receive the service, and provide the received information to a service provider. Also, the electronic coupon server 103 may receive and classify at least one piece of information among pieces of information about a user, provider, service type, service satisfaction, service time, and the transference of an electronic coupon, and may receive a user authentication request from the user, which wants to receive the service, and authenticate the user if it is determined that the user corresponds to an authorized user.

The electronic coupon server 103 is also connected to the electronic coupon database 105.

The electronic coupon database 105 stores at least one piece of information among pieces of information about a user, provider, service type, service satisfaction, service time, and transference of an electronic coupon, and may output the stored pieces of information according to a request of the electronic coupon server 103.

The user 113 may request an issue of the user smart card 109, request an issue of an electronic coupon, request an approval of the user, and request the service to the electronic coupon server 103.

Requesting the issue of the user smart card 109, requesting the issue of an electronic coupon, requesting an approval of the user, and requesting the service may be performed through the user terminal 115. The user terminal 115 may be, for example, a computer.

A service provider 117 may request a service provider registration, request an issue of the service provider smart card 111, request an approval of a service provider, and request a service charge to be settled, to the electronic coupon server 103.

Requesting a service provider registration, requesting an issue of the service provider smart card 111, requesting an approval of a service provider, and requesting a service charge to be settled may be performed through the service provider terminal 119. The service provider terminal 119 may be, for example, a computer.

Also, when the service provider 117 has received a service provision request from the electronic coupon server 103, the service provider 117 provides a corresponding service to the user 113.

The user smart card 109 and the service provider smart card 111 have an electronic coupon service function according to the present invention.

Generally, a smart card includes a plastic card and an integrated circuit chip attached on the surface of the plastic card, and includes a CPU and a logic operation circuit therein so as to store and process information.

The user smart card 109 may store at least one piece of information among user information, information about service types to be usable by the user, information about the number of electronic coupons, and information about an available period of each electronic coupon, and the service provider smart card 111 may include information about a service provider.

The user smart card 109 and the service provider smart card 111 may include at least one function among a cash card function, a check card function, and a credit card function, in addition to the electronic coupon service function, and may additionally include a traffic card function and an identification card function.

When the user smart card 109 is inserted into the service terminal 107, the service terminal 107 distributes an electronic coupon issued by the electronic coupon server 103 to the user smart card 109, and may transfer an electronic coupon stored in the user smart card 109 to the service provider smart card 111 at the time of providing a service by the service provider.

Also, the service terminal 107 can set a service start time and a service end time through successive insertion of the user smart card 109 and the service provider smart card 111 into the service terminal 107, can receive a user satisfaction rating of the service, and can transmit at least one piece of information among pieces of information about a user, provider, service type, service satisfaction, service time, and transference of an electronic coupon, to the electronic coupon server 103.

According to an exemplary embodiment of the present invention, the electronic coupon includes both the electronic coupons and the electronic points. Services using the electronic coupon are not limited to a specific form, and may be, for example, a voucher service. Therefore, the electronic coupon may be a voucher electronic coupon.

FIG. 2 is a block diagram illustrating the configuration of the service terminal according to an exemplary embodiment of the present invention.

Referring to FIG. 2, the service terminal 107 may include a controller 201, a smart card interface 203, a key input unit 205, a transmission interface 207, a display unit 209, and a memory 211.

The smart card interface 203 reads information recorded in the user smart card 109 and the service provider smart card 111, and transmits the read information to the controller 203. The smart card interface 203 may be a contact interface or a contactless interface.

The key input unit 205 receives various pieces of information, for example, information about a service satisfaction, etc., from the user 113 or the service provider 117, and transmits the received information to the controller 203.

The memory 211 may store the entire or a part of a program for achieving the present invention, and may store at least one piece of information among pieces of information about a user, provider, service type, service satisfaction, service time, and transference of an electronic coupon.

The transmission interface 207 is connected to the network 101 so as to transmit information, which has been input through the key input unit 205 and the smart card interface 203, to the electronic coupon server 103.

The service terminal 107 may be a portable communication terminal or a portable information terminal capable of performing the method according to the present invention. The portable communication terminal includes, for example, a cellular phone having a wireless communication function, etc., and the portable information terminal includes a PDA and a palmtop computer capable of wired/wireless communication functions.

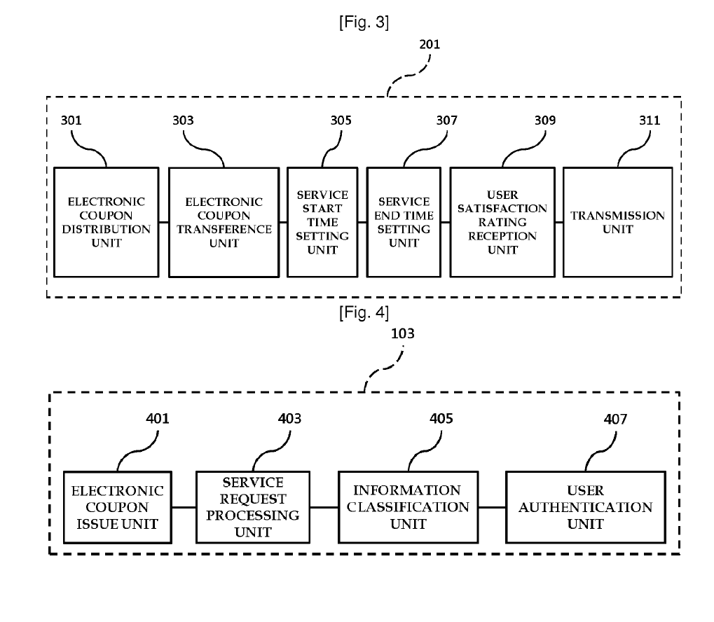

FIG. 3 is a block diagram illustrating the configuration of the controller in the service terminal according to an exemplary embodiment of the present invention.

Referring to FIG. 3, the controller 201 of the service terminal includes an electronic coupon distribution unit 301, an electronic coupon transference unit 303, a service start time setting unit 305, a service end time setting unit 307, a user satisfaction rating reception unit 309, and a transmission unit 311.

The electronic coupon distribution unit 301 distributes an electronic coupon issued by the electronic coupon server 103 to the user smart card 109 when the user smart card 109 has been inserted. If the user 113 is allocated an electronic coupon through the user terminal 115, there may be a problem in that the user must purchase new hardware, and especially, such a problem may occur when the user 113 has no user terminal 115 at all. In contrast, according to the electronic coupon distribution unit 301 of the present invention, there is an advantage in that the user 113 can be allocated an electronic coupon without purchasing new hardware.

The electronic coupon transference unit 303 transfers an electronic coupon stored in the user smart card 109 to the service provider smart card 111 at the time of providing a service by the service provider 117. Accordingly, it is possible to prevent illegal use of the electronic coupon from the beginning.

The service start time setting unit 305 sets a service start time when the user smart card 109 and the service provider smart card 111 are successively inserted into the service terminal 107, and the service end time setting unit 307 sets a service end time when the user smart card 109 and the service provider smart card 111 are successively inserted into the service terminal 107. As described above, the service start time setting unit 305 and service end time setting unit 307 are established in such a manner that an input to the units 305 and 307 is possible only when the user smart card 109 and the service provider smart card 111 are successively inserted. As a result, an electronic coupon is transferred only when service is actually provided, thereby preventing illegal use of the electronic coupon from the beginning.

The user satisfaction rating reception unit 309 receives a user satisfaction rating of the service, and the transmission unit 311 transmits at least one piece of information among pieces of information about a user, provider, service type, service satisfaction, service time, and transference of an electronic coupon, to the electronic coupon server 103.

FIG. 4 is a block diagram illustrating the configuration of the electronic coupon server according to an exemplary embodiment of the present invention.

Referring to FIG. 4, the electronic coupon server 103 includes an electronic coupon issue unit 401, a service request processing unit 403, an information classification unit 405, and a user authentication unit 407.

The electronic coupon issue unit 401 issues an electronic coupon to an authenticated user smart card 109, at the request of the user 113 who wants the electronic coupon to be issued.

The service request processing unit 403 receives information about a service request from the user 113, who wants to receive the service, and provides the received information to the service provider 117.

The information classification unit 405 receives at least one piece of information among pieces of information about a user, provider, service type, service satisfaction, service time, and transference of an electronic coupon, and classifies the received information.

The user authentication unit 407 receives a user approval request from a person, who wants to receive the service, and authenticates if the person corresponds to an authorized user.

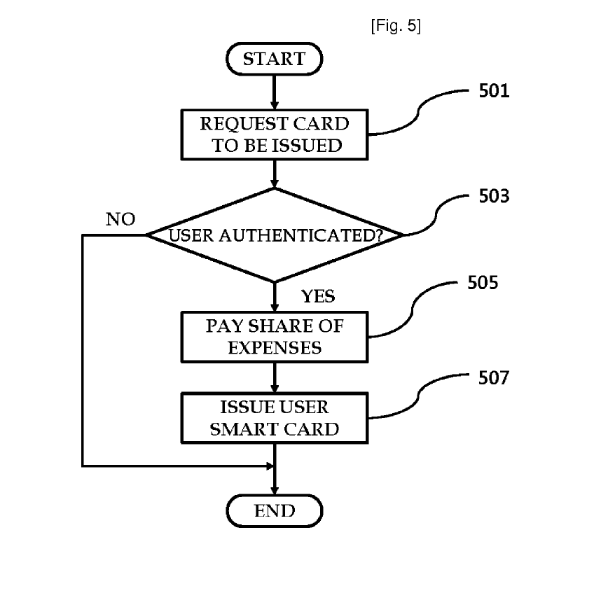

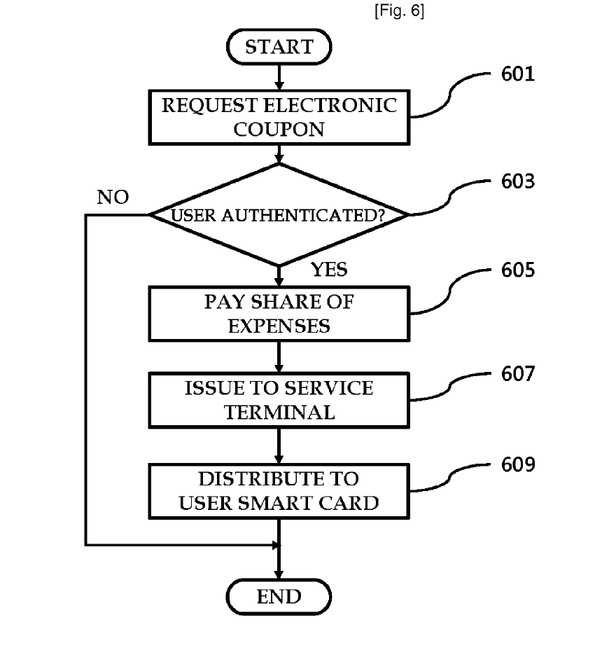

FIG. 5 is a flowchart illustrating a procedure of issuing the user smart card according to an exemplary embodiment of the present invention.

Referring to FIG. 5, first, a person who wants a user smart card to be issued and wants to use service requests the electronic coupon server 103 to issue a card in step 501. The electronic coupon server, which has been received the request, performs an authentication process so as to determine if the requester corresponds to a user capable of receiving the service, i.e. if the requester corresponds to an authorized user in step 503.

If the user is authenticated, the fact that the user is authenticated is notified and a share of expenses to be paid is notified. The share of expenses may be paid through an account opened in a bank. When the share of expenses has been paid in step 505, a user smart card is issued in step 507. The user smart card may store an electronic coupon which corresponds to or is proportional to the share of expenses.

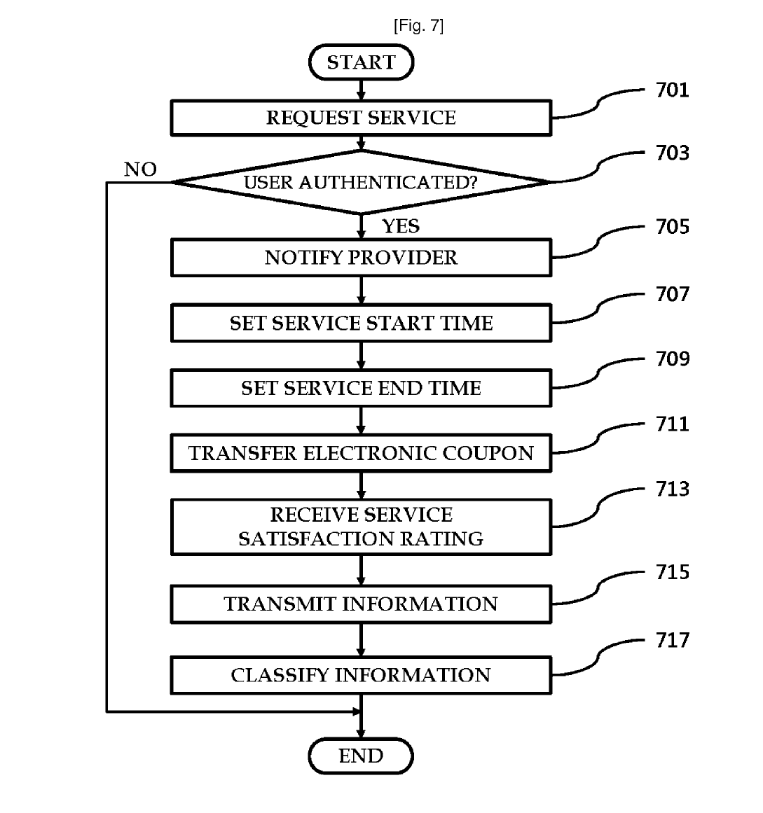

FIG. 6 is a flowchart illustrating a procedure of issuing an electronic coupon according to an exemplary embodiment of the present invention.

Referring to FIG. 6, first, a user transmits a user approval request and an electronic coupon request to the electronic coupon server in step 601. The electronic coupon server receives the user approval request, and determines if the requester corresponds to an authorized user in step 603. If the user is authenticated, it is determined if a share of expenses has been paid. When the share of expenses has been paid (step 605), the electronic coupon server issues an electronic coupon, which corresponds to or is proportional to the share of expenses, to the service terminal in step 607. Thereafter, when the user smart card is inserted into the service terminal, the service terminal distributes the electronic coupon issued by the electronic coupon server to the user smart card in step 609.

FIG. 7 is a flowchart illustrating an electronic coupon service method using a smart card according to an exemplary embodiment of the present invention.

Referring to FIG. 7, first, a user transmits a user approval request and a service request to the electronic coupon server in step 701. The electronic coupon server receives the user approval request from the requester, and determines if the requester corresponds to an authorized user in step 703. If the user is authenticated, the electronic coupon server notifies the service provider of information about the service request in step 705.

Thereafter, the service provider calls at the user's house, and provides service. First, a service provider smart card is inserted into the service terminal, and authentication of the service provider is performed. Next, a user smart card and the service provider smart card are successively inserted into the service terminal, and a service start time is set, thereby providing a corresponding service (step 707). When the corresponding service is terminated, the user smart card and the service provider smart card are successively inserted into the service terminal, and a service end time is set (step 709). Then, the electronic coupon stored in the user smart card is transferred to the service provider smart card by means of the service terminal at the time of providing a service by the service provider in step 711.

Next, a user satisfaction rating of the service is received through the service terminal in step 713, and the service terminal transmits at least one piece of information among pieces of information about the user, provider, service type, service satisfaction, service time, and transference of an electronic coupon, to the electronic coupon server in step 715.

Next, the electronic coupon server receives at least one piece of information among pieces of information about the user, provider, service type, service satisfaction, service time, and transference of an electronic coupon, classifies the information in step 717, and stores the information in the electronic coupon database. Thereafter, it is possible to obtain required information by searching for the information according to each item, when necessary.

The electronic coupon service method using a smart card according to the present invention can be realized as a computer-readable code in a computer-readable recoding medium. The computer-readable recording medium includes all kinds of recording media, in which the computer-readable data is stored. The computer-readable recording medium may be a ROM, a RAM, a CDROM, a magnetic tape, a floppy disk, or an optical data recording medium, or also can be realized in the form of a carrier wave (e.g. transmission through the Internet). Also, the computer-readable recording medium is distributed to the computer systems connected by a network, and can store and perform the computer-readable code in a distributed way.

### INDUSTRIAL APPLICABILITY

As described above, according to the electronic coupon service system and method using a smart card, it is possible to reflect the opinion of a user, who receives the service (e.g. a social welfare service) using the electronic coupon, in the service system, thereby promoting improvement of the service system. Also, according to the present invention, it is possible to completely remove a probability that an electronic coupon is not provided as payment for a planned specific service, and is illegally used for other services or products.

In addition, according to the present invention, it is easy to identify information about types of service for which electronic coupons have been used, the number of times of use, provider preferences, etc., so that public institutions can easily identify current problems of the voucher system, and improvement in the quality of service provided by providers can be expected.

Although several preferred embodiments of the present invention have been described for illustrative purposes, those skilled in the art will appreciate that various modifications, additions and substitutions are possible, without departing from the scope and spirit of the invention as disclosed in the accompanying claims. Accordingly, the scope of the present invention must be defined by the technical aspects of the appended claims.

1. A system for an electronic coupon service using a smart card, the system comprising:
an electronic coupon server for issuing an electronic coupon to an authenticated user smart card at the request of a user who wants the electronic coupon to be issued; and
a service terminal for distributing the electronic coupon, which has been issued by the electronic coupon server, to the user smart card when the user smart card is inserted into the service terminal,
wherein the service terminal comprises an electronic coupon transference unit, which transfers the electronic coupon stored in the user smart card to a service provider smart card at the time of providing the service by the service provider.

2. The system as claimed in claim 1, wherein the user smart card stores at least one piece of information among user information, information about service types to be usable by the user, information about the number of electronic coupons, and information about an available period of each electronic coupon, and the service provider smart card comprises information about a service provider.

3. The system as claimed in claim 1, wherein the service terminal further comprises a service start time setting unit for setting a service start time when the user smart card and the service provider smart card are successively inserted into the service terminal.

4. The system as claimed in claim 1, wherein the service terminal further comprises a service end time setting unit for setting a service end time when the user smart card and the service provider smart card are successively inserted into the service terminal.

5. The system as claimed in claim 1, wherein the service terminal further comprises a user satisfaction rating reception unit for receiving a user satisfaction rating of the service.

6. The system as claimed in claim 1, wherein the service terminal further comprises a transmission unit, which transmits at least one piece of information among pieces of information about the user, provider, service type, service satisfaction, service time, and transference of an electronic coupon, to the electronic coupon server.

7. The system as claimed in claim 1, wherein the electronic coupon server further comprises a service request processing unit, which receives information about a service request from the user who wants to receive the service, and provides the received information to a service provider.

8. The system as claimed in claim 1, wherein the electronic coupon server further comprises an information classification unit, which receives at least one piece of information among pieces of information about the user, provider, service type, service satisfaction, service time, and transference of an electronic coupon, and classifies the received information.

9. The system as claimed in claim 1, wherein the electronic coupon server further comprises a user authentication unit, which receives a user approval request from a person who wants the service, and performs authentication of the person.

10. The system as claimed in claim 1, further comprising an electronic coupon database for storing at least one piece of information among pieces of information about the user, provider, service type, service satisfaction, service time, and transference of an electronic coupon.

11. The system as claimed in claim 1, wherein the electronic coupon comprises a voucher electronic coupon.

12. A method for an electronic coupon service using a smart card, the method comprising the steps of:
issuing, by an electronic coupon server, an electronic coupon to an authenticated user smart card at the request of a user who wants the electronic coupon to be issued;
distributing, by a service terminal, the electronic coupon, which has been issued by the electronic coupon server, to the user smart card when the user smart card is inserted into the service terminal; and
transferring, by the service terminal, the electronic coupon stored in the user smart card to a service provider smart card at the time of providing the service by the service provider.

13. The method as claimed in claim 12, wherein the user smart card stores at least one piece of information among user information, information about service types to be usable by the user, information about the number of electronic coupons, and information about an available period of each electronic coupon, and the service provider smart card comprises information about a service provider.

14. The method as claimed in claim 12, further comprising a step of setting, by the service terminal, a service start time when the user smart card and the service provider smart card are successively inserted into the service terminal.

15. The method as claimed in claim 12, further comprising a step of setting, by the service terminal, a service end time when the user smart card and the service provider smart card are successively inserted into the service terminal.

16. The method as claimed in claim 12, further comprising a step of receiving, by the service terminal, a user satisfaction rating of the service.

17. The method as claimed in claim 12, further comprising a step of transmitting, by the service terminal, at least one piece of information among pieces of information about the user, provider, service type, service satisfaction, service time, and transference of an electronic coupon, to the electronic coupon server.

18. The method as claimed in claim 12, further comprising a step of receiving, by the electronic coupon server, information about a service request from the user who wants to receive the service, and providing the received information to a service provider.

19. The method as claimed in claim 12, further comprising a step of receiving, by the electronic coupon server, at least one piece of information among pieces of information about the user, provider, service type, service satisfaction, service time, and transference of an electronic coupon, and classifying the received information.

20. The method as claimed in claim 12, further comprising a step of receiving, by the electronic coupon server, a user approval request from a person who wants the service, and performing authentication of the person.

21. The method as claimed in claim 12, further comprising a step of storing at least one piece of information among pieces of information about the user, provider, service type, service satisfaction, service time, and transference of an electronic coupon in an electronic coupon database.

22. The method as claimed in claim 12, wherein the electronic coupon comprises a voucher electronic coupon.
